(19) United States
(12) Patent Application Publication
(10) Pub. No.: US 2018/0024044 A1
(43) Pub. Date: Jan. 25, 2018

(54) CORROSION TESTER TOOL FOR USE DURING DRILL STEM TEST

(71) Applicant: Halliburton Energy Services, Inc., Houston, TX (US)

(72) Inventors: Paul David Ringgenberg, Frisco, TX (US); Fernando Marcancola, Macae (BR); Luis Fernando Lemus, Rio de Janeiro (BR)

(21) Appl. No.: 15/547,874

(22) PCT Filed: Mar. 26, 2015
(86) PCT No.: PCT/US2015/022727

§ 371 Date: Aug. 1, 2017

(51) Int. Cl. G01N 17/04; E21B 49/08

(52) U.S. Cl. CPC G01N 17/046; E21B 49/088; E21B 34/06

(57) ABSTRACT

In accordance with embodiments of the present disclosure, systems and methods for gathering corrosion data during a drill stem test (DST) performed in a wellbore extending through a subterranean formation are provided. Such systems include a specialized tool that may be run into the wellbore on a DST tubular string to perform corrosion measurements during the DST. This corrosion tester tool (CTT) may include a number of material coupons disposed therein for exposure to formation fluids routed through the CTT and the DST tubular string. The CTT may hold material coupons of several different materials that could potentially be used to form production tubing or other production equipment needed for well completion operations. After the different material coupons are exposed to the formation fluid via the CTT, the material coupons may be inspected to determine which material should be used to form the production tubing/equipment for that particular well.

### TECHNICAL FIELD

The present disclosure relates generally to drill stem testing equipment and, more particularly, corrosion tester tools for use during a drill stem test.

### BACKGROUND

Hydrocarbons, such as oil and gas, are commonly obtained from subterranean formations that may be located onshore or offshore. The development of subterranean operations and the processes involved in removing hydrocarbons from a subterranean formation typically involve a number of different steps such as, for example, drilling a wellbore at a desired well site, treating the wellbore to optimize production of hydrocarbons, and performing the necessary steps to produce and process the hydrocarbons from the subterranean formation.

Upon drilling a wellbore that intersects a subterranean hydrocarbon-bearing formation, a variety of downhole tools may be positioned in the wellbore during exploration, completion, production, and/or remedial activities. For example, a drill stem test (DST) is commonly employed to determine the productive capacity, pressure, permeability, and/or extent of a hydrocarbon reservoir. DSTs are usually conducted utilizing a downhole shut-in tool that allows the well to be opened and closed at the bottom of the hole, for example, via a valve which may be actuated at the surface. Typically, during a DST, the zone of interest is isolated and reservoir fluids are allowed to flow through the drill string (e.g., pipe) for a time period. A DST may be used to measure the flow rate of the fluids from the formation, the temperature and/or pressure associated with the formation, or combinations thereof. In addition, samples of fluids produced from the DSTs are collected and analyzed to determine a variety of parameters which may be related to production, such as the extent of resources (e.g., oil or gas) present in the formation.

Fluid samples that are collected through the DSTs are often analyzed in a lab to determine a variety of parameters including, for example, corrosiveness of the formation fluid. Decisions regarding what materials to use for the production tubing to be laid into the wellbore are often made based on these corrosion tests. These laboratory tests for evaluating the corrosion resistance of certain materials to the sampled formation fluid often require assumptions to be made regarding the conditions in the wellbore. Assumptions may include, for example, the amount of downhole pressure experienced at a certain depth, the amount of carbon dioxide in the formation, and so forth. If these assumptions do not match up with the actual downhole conditions experienced in the wellbore, the corrosion test can be inaccurate. This can lead to selection of production tubing material that is not well suited for the particular wellbore, resulting in a loss of time and/or money spent on the production tubing.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a schematic illustration of a drilling system including a corrosion tester tool on a drill stem testing string, in accordance with an embodiment of the present disclosure;

FIG. 2 is a schematic cross sectional view of a corrosion tester tool arranged to perform corrosion tests under dynamic flow conditions, in accordance with an embodiment of the present disclosure;

FIG. 3 is a detailed view of a portion of the corrosion tester tool of FIG. 2, in accordance with an embodiment of the present disclosure;

FIG. 4 is a schematic cross sectional view of a turbine configuration of corrosion test samples for use in a corrosion tester tool, in accordance with an embodiment of the present disclosure;

FIG. 5 is a schematic cross sectional view of a corrosion tester tool arranged to perform corrosion tests under near static flow conditions, in accordance with an embodiment of the present disclosure;

FIG. 6 is a schematic cross sectional view of a corrosion tester tool arranged to perform corrosion tests while the test samples are held under tensile stress, in accordance with an embodiment of the present disclosure;

FIG. 7 is a perspective view of a mechanism for pre-stressing a corrosion test sample used in a corrosion tester tool, in accordance with an embodiment of the present disclosure; and

FIG. 8 is a schematic cross sectional view of a corrosion tester tool arranged to perform long run corrosion tests, in accordance with an embodiment of the present disclosure.

### DETAILED DESCRIPTION

Illustrative embodiments of the present disclosure are described in detail herein. In the interest of clarity, not all features of an actual implementation are described in this specification. It will, of course, be appreciated that in the development of any such actual embodiment, numerous implementation-specific decisions must be made to achieve developers' specific goals, such as compliance with system-related and business-related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

Certain embodiments according to the present disclosure may be directed to systems and methods for gathering corrosion data during a drill stem test (DST) performed in a wellbore extending through a subterranean formation. The corrosion data may be used to properly design a production tubing string and various production equipment (e.g., production packers, lock mandrels, seal assemblies, and expansion joints) used to produce formation fluids through the wellbore.

The DST is generally performed after a section of the wellbore is drilled, in order to determine various properties of the wellbore and the formation of interest. The DST is performed using a string of tubular equipped with at least an isolation component to isolate a section of the wellbore for testing and a valve to route fluids from the formation into the DST tubular string for tests. Sensors and other equipment may generally be placed along the DST tubular string to determine measurements related to a flow rate, temperature, or pressure in the formation. In addition, fluid samplers may be positioned along the DST tubular string to take samples of the formation fluid for later analysis in a lab.

The present disclosure is related to a specialized tool that may be run into the wellbore on the DST tubular string and used to perform corrosion measurements during the DST. This corrosion tester tool (CTT) may include a number of material coupons disposed therein for exposure to formation fluids routed through the CTT and the DST tubular string. In some embodiments, the material coupons may each include a solid piece formed entirely from the material to be tested, while in other embodiments the material coupons may each include a base material coated with the material to be tested. Other processing techniques may be used as well to form the material coupons with the material to be tested. The CTT may hold material coupons of several different materials, coatings, or processing methods that could potentially be used to form production tubing or other production equipment needed for well completion operations. After the different material coupons are exposed to the formation fluid via the CTT, the material coupons may be inspected and analyzed to determine which material should be used to form the production tubing/equipment for that particular well. Since some of the more corrosion-resistant tubing materials are expensive, the decision of which material to use for the production tubing/equipment may involve an optimization based on corrosion resistance and cost of the materials.

The presently disclosed CTT may be used to expose different material coupons to the actual downhole conditions that are present in the wellbore. This level of accuracy may not be available through existing laboratory corrosion tests performed at the surface using formation fluid gathered during a DST. Specifically, the disclosed CTT may enable the formation fluid to corrode the different tested materials under actual downhole conditions, instead of relying on assumptions of the downhole conditions. As described below, the CTT may enable the material coupons to be tested under both dynamic flow conditions and static or near static flow conditions. In addition, some embodiments of the CTT may enable the material coupons to be tested under tensile stress. Thus, the disclosed CTT may enable corrosion testing of materials downhole and under a variety of different conditions.

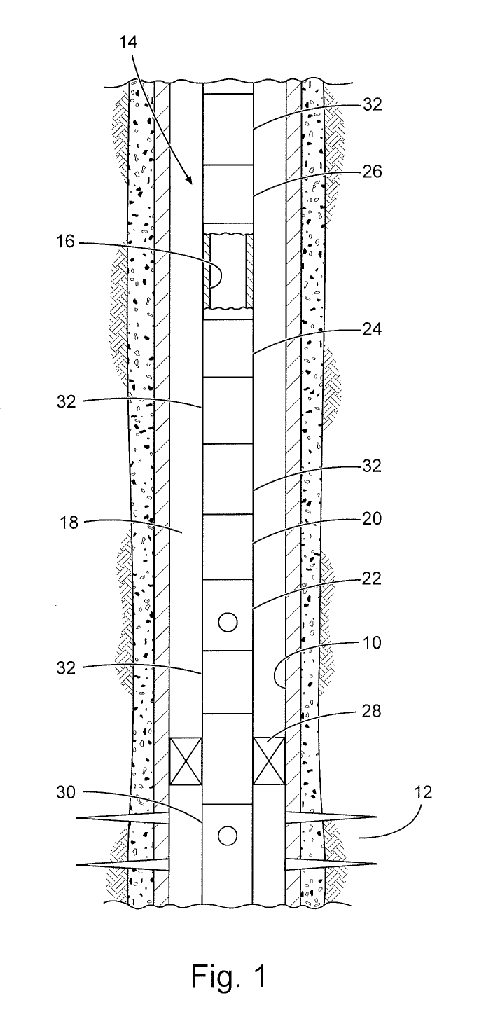

Turning now to the drawings, FIG. 1 is a schematic illustration of an operating environment in which a wellbore servicing apparatus and/or system may be employed. The operating environment generally includes a wellbore 10 that penetrates a subterranean formation 12 for the purpose of recovering hydrocarbons. The wellbore 10 may be drilled into the subterranean formation 12 using any suitable drilling technique. Upon completion of drilling, a tubular string 14, such as a drill stem test string, may be positioned in the wellbore 10. An internal flow passage 16 extends longitudinally through the tubular string 14. The tubular string 14 may be designed to perform a drill stem test (DST) by controlling flow between the internal flow passage 16 of the tubular string 14, an annulus 18 formed radially between the tubular string 14 and the wellbore 10, and the formation 12 intersected by the wellbore 10. The wellbore 10 could be cased, as depicted in FIG. 1, or it could be uncased.

The tubular string 14 may include a variety of different components used to perform the DST on the wellbore 10. These components that are interconnected within the tubular string 14 may include, for example, a fluid sampler 20, a circulating valve 22, a tester valve 24, and a choke 26. The circulating valve 22, tester valve 24, and choke 26 may be of conventional design. It should be noted, however, that it is not necessary for the tubular string 14 to include the specific combination or arrangement of equipment described herein. The tubular string 14 may also include an inflatable packer 28 (or other isolation component) positioned above a potentially productive zone of the formation 12 that is to be tested. When the packer 28 is inflated, it expands against the wall of the wellbore 10 (or casing) to isolate this zone of the formation 12. The tubular string 14 may also include a formation fluid port or flow path 30 below the packer 28 through which fluids from the formation 12 may flow into the flow passage 16 of the tubular string 14 during testing.

In a formation testing operation (i.e., DST), the tester valve 24 may be controlled to selectively permit and prevent a flow of fluid from the formation 12 through the internal flow passage 16. The circulating valve 22 may be controlled to selectively permit and prevent flow between the passage 16 and the annulus 18 above the packer 28. The choke 26 may be controlled to selectively restrict flow through upper portions of the tubular string 14. Each of the valves 22, 24 and choke 26 may be operated by manipulating a pressure in the annulus 18 from the surface, or any of them could be operated by other methods if desired.

The valves 22, 24 and choke 26 may also be selectively operated to direct a flow of fluid from the formation 12 into one or more sample bottles disposed in the fluid sampler 20. After completing the DST, the fluid collected in the fluid sampler 20 may be retrieved to the surface for additional laboratory tests to determine various properties of the formation 12.

In addition to these components, the tubular string 14 may also be equipped with one or more corrosion tester tools (CTTs) 32 interconnected with the drill stem test equipment. These CTTs 32 may be used to expose coupons of various materials that may potentially be used to construct production tubing for later use in the wellbore 10. The coupons of different materials may be arranged so that they are exposed to the formation fluid being routed through the tubular string 14. As described in detail below, one or more of the CTTs 32 may be configured to expose the material coupons to a dynamic flow of formation fluid through the internal flow passage 16. Other CTTs 32 may be configured to expose the material coupons to a near static flow of formation fluid through an annular flow passage of the tubular string 14. In addition, one or more of the CTTs 32 may hold the material coupons under tensile stress while exposing the coupons to the flow of formation fluid through the tubular string 14.

In general, the CTTs 32 positioned along the tubular string 14 may facilitate more accurate corrosion testing than can be performed during surface laboratory tests using formation fluid samples. Specifically, the CTTs 32 may enable corrosion tests to be performed on the material coupons under the temperature, pressure, and other operating conditions experienced in the particular wellbore 10. The results from the corrosion tests performed downhole during the DST may be used to select an appropriate material for the production tubing to be placed in the wellbore 10. With more accurate information regarding the corrosion resistance of the materials in a particular wellbore 10, taken under a variety of conditions, operators may select a production tubing material that is more accurately optimized for cost and corrosion resistance. In addition, the CTTs 32 may enable corrosion tests to be performed downhole during DST operations, thereby saving additional time that would otherwise be spent analyzing coupons in a lab.

As illustrated, the one or more CTTs 32 may be disposed at various positions along the DST tubular string 14. In this manner, the CTTs 32 may be run at different depths in the wellbore 10 to evaluate the effect of different temperature and pressure conditions on the corrosion formed on the material coupons. In addition, the CTTs 32 may be positioned both below and above the DST tester valve 24 to evaluate whether the corrosion on the material coupons differs as the wellbore 10 is shut-in (i.e., the formation fluid is no longer allowed to travel up the DST tubular string 14). As illustrated, one or more CTTs 32 may be disposed higher up in the tubular string, above all the components (e.g., 26, 24, 20, 22, 28, and 30) used to perform the DST.

Even though FIG. 1 depicts a vertical well, it should be noted that the presently disclosed CTT 32 may be equally well-suited for use in deviated wells, inclined wells or horizontal wells. As such, the use of directional terms such as above, below, upper, lower, upward, downward and the like are used in relation to the illustrative embodiments as they are depicted in the figures, the upward direction being toward the top of the corresponding figure and the downward direction being toward the bottom of the corresponding figure.

In some embodiments, the same DST tubular string 14 equipped with one or more CTTs 32 may be used to test a number of different wellbores 10 or wellsites formed in a particular region. The corrosion test results from the different wellbores 10 may be used to determine how well a particular production tubing/equipment material might hold up in the given region. Thus, it may be desirable to look at the corrosion test results from the entire area around a particular wellbore 10 in order to determine an appropriate material that can be used for the production tubing/equipment in the wellbore 10.

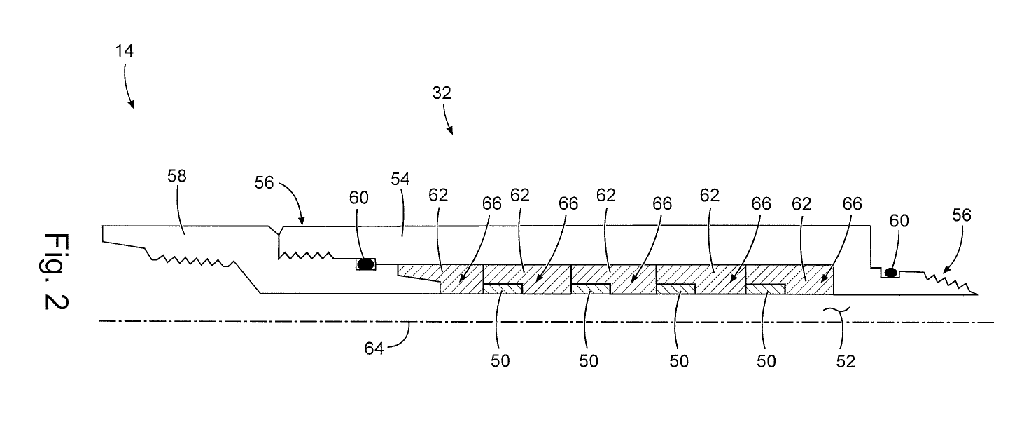

Different CTTs 32, or different portions of a single CTT 32, may be designed to test material coupons under different flow conditions of the formation fluid being routed through the DST tubular string 14. For example, the CTT 32 may include features for exposing the material coupons to a dynamic flow of formation fluid through the DST tubular string 14 and the CTT 32. FIG. 2 illustrates a schematic embodiment of one such CTT 32 designed to expose material coupons 50 to dynamic flow conditions. The illustrated CTT 32 may be used to maximize contact between the material coupons 50 and the flow velocity of formation fluid being routed through a central flow passage 52 of the CTT 32 and the DST tubular string 14.

In the illustrated embodiment, the CTT 32 may include an external tool housing 54 used to provide structural support and to protect the internal components of the CTT 32 from the wellbore environment. The housing 54 may include threaded ends 56 for engaging with housings 58 used to protect adjacent components (e.g., sampler, valve, choke, flow path, or isolation component) of the DST tubular string 14. The threaded ends 56 of the housing 54 may be sealed against the adjacent housings 58 via an elastomeric seal 60 (e.g., O-ring).

The CTT 32 may also include mounting features 62 for mounting the one or more material coupons 50 within the CTT 32 in a position internal to the housing 54. As illustrated, the mounting features 62 may expose the material coupons 50 to the dynamic flow of formation fluid routed through the central flow passage 52. An outside edge of the coupons 50 may be coupled to the mounting features 62, this outside edge being the edge of the material coupon 50 that faces away from a centerline 64 of the CTT 32. In some embodiments, the mounting features 62 may be disposed along and/or coupled to an inner diameter of the housing 54 of the CTT 32. In other embodiments, the mounting features 62 may be integrally formed along the inner diameter of the housing 54. As illustrated, each of the material coupons 50 mounted in the CTT 32 may be held with a respective mounting feature 62. In other embodiments, a single mounting feature 62 may be used to mount all of the material coupons 50 in their desired positions within the CTT 32.

It is desirable to ensure that electrical insulation is provided between the different material coupons 50, particularly between the material coupons 50 made from different materials. This is because the material coupons 50, if electrically connected and exposed to the corrosive fluids, may undergo galvanic corrosion. This occurs when a material that is more noble (i.e., more corrosion resistant) is electrically connected with a material that is less noble and, as a result, transfers additional corrosion to the less noble material. To prevent such galvanic corrosion, which could lead to inaccurate corrosion measurements, the disclosed CTT 32 may include an electrical insulation material 66. This electrical insulation material 66 may include, for example, Teflon or polyether ether ketone (PEEK) used to provide electrical insulation between adjacent material coupons 50. Other types of electrical insulation materials 66 may be used as well.

The electrical insulation material 66 may be disposed inside the housing 54 and proximate the material coupons 50 to prevent galvanic corrosion. For example, in the illustrated embodiment, the mounting features 62 may be constructed from this electrical insulation material 66 so that the mounting features 62 act as insulating spacers within the CTT assembly. In other embodiments, at least a portion of the mounting features 62 may generally include the electrical insulation material 66, this portion being at the part of the mounting feature 62 that directly contacts the material coupons 50. In still other embodiments, the electrical insulation material 66 may be a coating applied to the edge of the mounting feature 62 used to contact the material coupons 50. In further embodiments, the electrical insulation material 66 may be provided as a separate component entirely from the mounting features 62. As shown, the mounting features 62 and/or the electrical insulation material 66 may be designed to extend between adjacent material coupons 50 arranged within the CTT 32.

The different material coupons 50 illustrated may include different types of materials that are being tested for corrosion resistance under actual wellbore conditions via the CTT 32. In some embodiments, the material coupons 50 may each include a solid piece formed entirely from the material to be tested, while in other embodiments the material coupons 50 may each include a base material coated with the material to be tested, or may be formed by another processing technique. The material coupons 50 may be made from the exact materials that are often used in standard API grade production tubing. For example, one or more of the material coupons 50 in the CTT 32 may be made from L80 low alloy steel, Inconel® alloy 718, or 13-Chrome steel. However, it should be noted that other materials may be tested as coupons 50 within the disclosed CTT 32. These material coupons 50 are not limited to existing materials, but could also be formed from any materials that are later developed and introduced into production tubing/equipment.

As illustrated, the material coupons 50 may be cylindrical in shape and arranged longitudinally along a length of the CTT 32 in a direction of the centerline 64. In other embodiments, however, the material coupons 50 may include other shapes such as, for example, square, rectangular, oval, oblong, circular, or an irregular shape. The material coupons 50 may be any desired size such as, for example, 30 mm in length for the cylindrical coupons, 30 mm×30 mm in area for square coupons, or 30 mm in diameter for circular coupons. The material coupons 50 may have any desirable thickness in a direction substantially perpendicular to the surface exposed to the formation fluid flowing past the coupons 50. In some embodiments, the coupons 50 may be arranged with at least 30 mm of space between adjacent material coupons 50. This space may be filled in at least partially with the electrical insulation material 66. The inner surfaces of the material coupons 50, that is the surfaces exposed to the dynamic flow of formation fluid, may not be flat or smooth in some embodiments.

Other shapes and sizes of the material coupons 50 may be used to fit the coupons 50 into a CTT 32 of any desired dimensions for the wellbore being evaluated. For example, in a wellbore that can support a 12.7 cm diameter tool, the CTT 32 may include material coupons 50 housed therein and having an inner diameter of up to approximately 60 mm. However, it should be noted that any desirable shape, size, or general arrangement of material coupons 50 may be supported in the disclosed CTT 32.

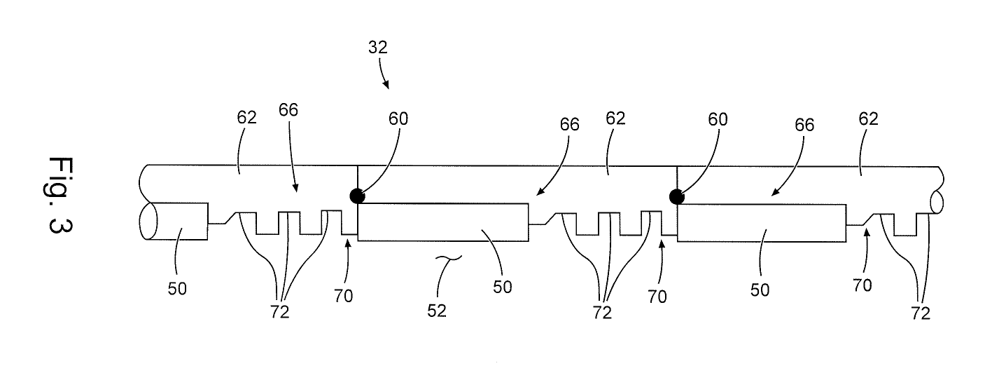

FIG. 3 illustrates a close up view of certain components of the CTT 32 described above. As illustrated, additional elastomeric seals 60 (e.g., O-rings) may be positioned between adjacent mounting features 62 and/or insulating spacers 66. In addition, the illustrated mounting features 62 and/or spacers 66 may include an intentionally non-smooth surface 70 facing the central flow passage 52 of the CTT 32. These non-smooth surfaces 70 may be located between adjacent material coupons 50, and may include grooves 72 or other textured features for increasing the turbulence of the flow of formation fluid through the central flow passage 52. That is, the grooves 72 may produce a more turbulent flow of fluid through the central flow passage 52, thereby making the flow of formation fluid more dynamic as it contacts the exposed faces of the material coupons 50 mounted in the CTT 32.

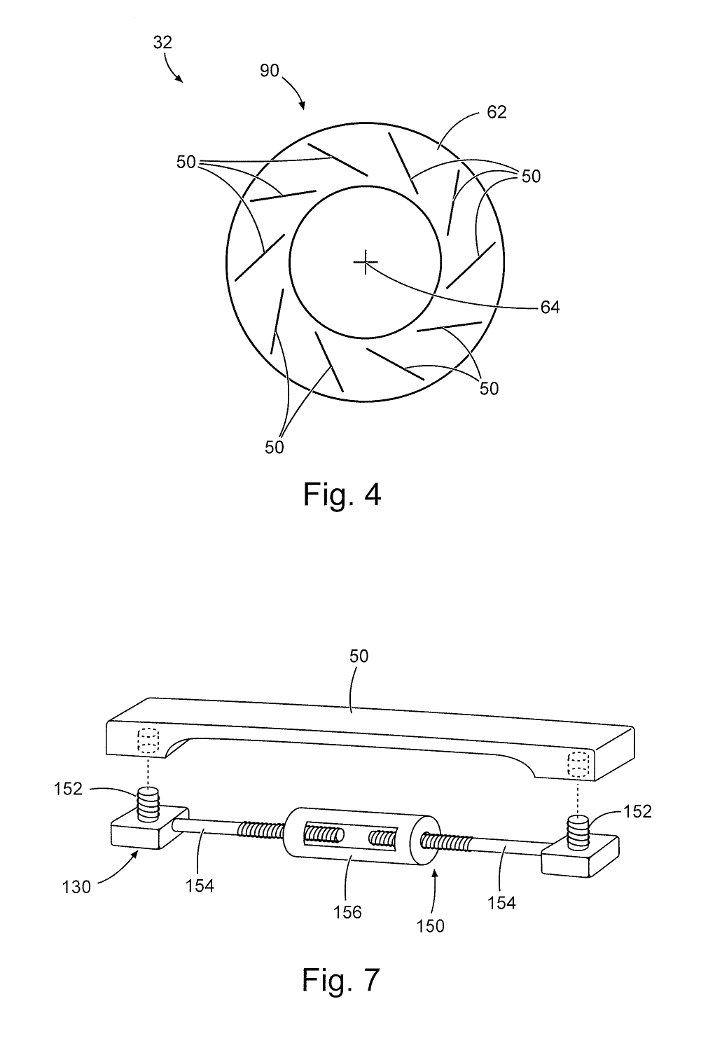

FIG. 4 illustrates an embodiment of the CTT 32 where multiple material coupons 50 may be arranged in a turbine configuration 90. The turbine configuration 90 involves flat material coupons 50 being disposed at angles from one another in a circumferential arrangement relative to the centerline 64 and within an annular area of the CTT 32. This configuration 90 may be utilized when the material coupons are formed in flat shapes (i.e., rectangular, square, circular, etc.). The CTT 32 may include a single mounting feature 62 (or multiple mounting features 62) designed to hold the multiple material coupons 50 in the turbine configuration 90. The turbine configuration 90 may be utilized for mounting the coupons 50 for a dynamic flow corrosion test or a near static flow corrosion test.

The turbine configuration 90 may be used to expose a relatively large number of material coupons 50 to fluid flow within a relatively smaller space through the CTT 32. This arrangement may be particularly suited for testing coupons 50 of a large number of different materials. In some embodiments, it may be desirable to include coupons 50 of a single type of material in each turbine configuration 90, and to have multiple turbine configurations 90 of different material coupons 50 disposed at different points along the length of the CTT 32. In such instances, electrical insulation material (e.g., insulated spacers) may be disposed between the adjacent turbine configurations 90 of material coupons 50, to keep the different materials separate from each other and free of galvanic corrosion.

As mentioned above, different CTTs 32 (or portions of a single CTT 32) may be designed to test material coupons under different flow conditions of the formation fluid being routed through the DST tubular string. For example, the CTT 32 may include features for exposing the material coupons to a near static flow of formation fluid through the DST tubular string and the CTT 32. FIG. 5 illustrates a schematic embodiment of one such CTT 32 designed to expose material coupons 50 to near static flow conditions. The illustrated CTT 32 may be used to maximize contact between the material coupons 50 and a low flow velocity of formation fluid being routed through an annular flow passage 110 of the CTT 32.

Static or near static flow conditions of formation fluid may be experienced in production tubing/equipment when a wellbore is “shut in”, meaning that a flow is cut off between a lower portion of the wellbore and the upper production equipment. Under such static conditions, some materials used in the production tubing/equipment can form a passivating layer when exposed to particular downhole fluids. Once formed, this passivating layer effectively shields the material from any further corrosion. Accordingly, it can be beneficial to utilize materials for the production tubing/equipment that are known to generate a passivating layer under static wellbore conditions. Thus, by testing the material coupons 50 under near static conditions during the DST, the illustrated CTT 32 may provide corrosion resistance information relating to whether the materials develop a passivating layer, and this information may be useful in selecting an appropriate material for the production tubing/equipment.

The DST itself may provide information relating to an expected flow velocity to be experienced during production. If this expected flow velocity is low, this may further indicate that a material that develops a passivating layer should be used for the production tubing/equipment. In some instances, relatively large diameter production tubing/equipment may be selected in order to further reduce the expected flow velocity so that a passivating layer may develop during the production stage.

In the illustrated embodiment, the CTT 32 may include the external tool housing 54, similar to the housing described above with reference to FIG. 2. This housing 54 may provide structural support to the CTT 32 and may protect the internal components of the CTT 32 from the wellbore environment. The CTT 32 may also include a mandrel 112 disposed inside the housing 54.

The mandrel 112 may be used to separate the annular flow passage 110 between the mandrel 112 and the housing 54 from the central flow passage 52 internal to the mandrel 112. The mandrel 112 may feature a flow port entrance 114 at a lower end of the CTT 32 for routing formation fluid from the central flow passage 52 into the annular flow passage 110. Similarly, the mandrel 112 may feature a flow port exit 116 at an upper end of the CTT 32 opposite the flow port entrance 114, for routing the formation fluid from the annular flow passage 110 back to the central flow passage 52. The flow port entrance and exit 114 and 116 may be designed to restrict a flow of fluid entering and leaving the annular flow passage 110. This setup may enable the CTT 32 to isolate a relatively slow moving (nearly static) flow of formation fluid within the annular flow passage 110, separate from the more dynamic flow of formation fluid through the central flow passage 52 of the CTT 32 and the DST tubular string 14.

The mounting features 62 of the CTT 32 may form at least a portion of the mandrel 112 extending through the CTT 32. As illustrated, the material coupons 50 may be mounted to an outside edge of the mandrel 112 via the mounting features 62. The outside edge is generally the edge of the mandrel 112 that faces away from the centerline 64 of the CTT 32. Thus, the mounting features 62 are positioned to expose the material coupons 50 to a near static flow of formation fluid routed through the annular flow passage 110. In some embodiments, the mounting features 62 may be coupled to the mandrel 112 of the CTT 32. In other embodiments, the mounting features 62 may be integrally formed along an outer diameter of the mandrel 112. As illustrated, each of the material coupons 50 mounted in the CTT 32 may be held with a respective mounting feature 62. In other embodiments, a single mounting feature 62 may be used to mount all of the material coupons 50 in their desired positions within the CTT 32.

In the illustrated near static coupon test, the outer diameter (i.e., outer surface) of the material coupons 50 may be exposed to a very slow flow of formation fluid through the annular flow passage 110 during the slowing of the well. In this manner, the illustrated CTT 32 may expose the material coupons 50 to the wellbore fluids in a nearly static condition.

In some embodiments, the mandrel 112 and/or the mounting features 62 may include one or more centralizers 118 extending therefrom at positions proximate the mounted material coupons 50. As illustrated, the centralizers 118 may extend toward the inner diameter of the housing 54. The centralizers 118 may be wedge shaped such that they are wider at the base where the centralizers 118 are coupled to the mandrel 112 and thinner at the end extending toward the housing 54. The centralizers 118 may help to stabilize the mandrel 112 and the material coupons 50 within the housing 54. In addition, the centralizers 118 may help to reduce the flow velocity of fluid through the annular flow passage 110, particularly around the exposed surface of the material coupons 50. Thus, the centralizers 118 may help to keep the flow of formation fluid very slow against the coupons 50 within the CTT 32.

As discussed above, it may be desirable to ensure that electrical insulation (e.g., Teflon or PEEK) is provided between the different material coupons 50, to prevent galvanic corrosion of the material coupons 50 in the CTT 32. Thus, as discussed above, the electrical insulation material 66 may be disposed inside the housing 54 and proximate the material coupons 50 to prevent galvanic corrosion. In the illustrated embodiment, the mounting features 62 may be constructed from this electrical insulation material 66 so that the mounting features 62 act as insulating spacers within the CTT assembly. In other embodiments, at least a portion of the mounting features 62 may generally include the electrical insulation material 66, this portion being at the part of the mounting feature 62 that directly contacts the material coupons 50. In still other embodiments, the electrical insulation material 66 may be a coating applied to the edge of the mounting feature 62 used to contact the material coupons 50. In further embodiments, the electrical insulation material 66 may be provided as a separate component entirely from the mounting features 62. As shown, the mounting features 62 and/or the electrical insulation material 66 may be designed to extend between adjacent material coupons 50 arranged within the CTT 32.

The different material coupons 50 illustrated may include different types of materials that are being tested for corrosion resistance under actual wellbore conditions via the CTT 32, such as those described at length above with reference to FIG. 2. As illustrated, the material coupons 50 may be cylindrical in shape and arranged longitudinally along a length of the mandrel 112 in a direction of the centerline 64. In other embodiments, however, the material coupons 50 may include other shapes such as, for example, square, rectangular, oval, oblong, circular, or an irregular shape.

The material coupons 50 may be any desired size such as, for example, 20 mm in length for the cylindrical coupons, 20 mm×20 mm in area for square coupons, or 20 mm in diameter for circular coupons. The material coupons 50 may have any desirable thickness in a direction substantially perpendicular to the exposed face of the coupons 50. In some embodiments, the coupons 50 may be arranged with at least 20 mm of space between adjacent material coupons 50. This space may be filled in at least partially with the electrical insulation material 66. The outer surfaces of the material coupons 50, that is the surfaces exposed to the near static flow of formation fluid, may not be flat in some embodiments. Other shapes and sizes of the material coupons 50 may be used to fit the coupons 50 into a CTT 32 of any desired dimensions for the wellbore being evaluated.

In some embodiments, the number of material coupons 50 exposed to the fluid flow through the annular flow passage 110 of the CTT 32 may depend on the volume of fluid that can be contained in the annular flow passage 110. For example, an acceptable ratio of near static fluid volume to number of material coupons 50 may be approximately 250 mL of fluid per coupon 50. Due to the slow flow (instead of no flow) of formation fluid through the annular flow passage 110, the material coupons 50 may be contained in a smaller annular volume than would be utilized if the vessel were to hold completely static fluid. In some embodiments, the mounting features 62 and the material coupons 50 may be arranged in the turbine configuration of FIG. 4 within the annular flow passage 110 for completing the near static corrosion test on a relatively large number of material coupons 50.

It may be desirable to test the corrosion resistance of certain material coupons 50 under tensile loading. This is because the tensile failure rate and the corrosion rate of a given material can be influenced by each other and by certain downhole conditions. Production tubing that is used relatively close to the surface may undergo a relatively high amount of tensile stresses during its lifetime, and therefore may be particularly susceptible to these effects. To determine how certain materials corrode under higher levels of tensile stress, some embodiments of the CTT 32, or portions of the CTT 32, may include a tensile loading assembly designed to pre-stress the material coupon 50 prior to testing the material coupon 50 downhole. Such tensile loading assemblies may utilize one or more of the mounting features 62 to hold the material coupon under tensile stress during exposure of the material coupon 50 to the formation fluid.

FIG. 6 illustrates an embodiment of the CTT 32 including a tensile loading assembly 130 for pre-stressing the material coupon 50 to more closely simulate the stresses encountered in the tubing environment. Although only one tensile loading assembly 130 is illustrated, it should be noted that other tensile loading assemblies 130 may be arranged throughout the CTT 32. For example, multiple tensile loading assemblies 130 may be arranged circumferentially about the centerline 64, loaded into an annular space along the inner diameter of the housing 54. In addition, several tensile loading assemblies 130 may be installed at different longitudinal positions within a single CTT 32. The tensile loading assembly 130 may hold the material coupon 50 under tensile stress during the entire DST and simultaneous corrosion test.

In the illustrated embodiment, the material coupon 50 may be a cylindrical rod 132, and the tensile loading assembly 130 may include the mounting feature 62 formed as a tensile loading sleeve 134 (e.g., a hollow cylindrical sleeve for holding the rod). The material coupon rod 132 may be seated within a channel formed through the tensile loading sleeve 134 at one end. At an opposite end, the tensile loading sleeve 134 and the material coupon rod 132 may each include complementary threaded portions designed to engage with each other. The make-up of the threaded portions may be adjusted to increase or decrease the tensile load on the material coupon 50. In other embodiments, this rod and sleeve connection may be reversed, such that the material coupon 50 is formed as the sleeve component 134 and the rod 132 acts as the mounting (and tensile loading) feature 62.

The rod 132 and the sleeve 134 of the tensile loading assembly 130 may be made from the same material, in order to prevent galvanic corrosion between the two components. In addition, the illustrated tensile loading assembly 130 may include the electrical insulation material 66 for preventing galvanic corrosion between different material components being tested in the same CTT 32. As illustrated, the electrical insulation material 66 (e.g., Teflon or PEEK) may be included as end caps 136 positioned on opposite ends of the sleeve 134 (i.e., mounting feature 62). Electrical insulation material 66 may also be disposed along an external edge 138 of the tensile loading assembly 130 to shield the rod and sleeve from the external housing 54. In other embodiments, the electrical insulation material 66 may be used for a portion of, all of, or a coating on the mounting feature 62 (e.g., sleeve 134).

Other shapes, sizes, and arrangements of the material coupons 50 may be used in the tensile loading assembly 130 of the CTT 32. For example, in some embodiments, the material coupons 50 may be rectangular in shape. In such embodiments, the dimensions of the rectangular material coupon 50 (e.g., 15 mm×40 mm) may be selected based on a function of the Young's modulus of the particular material being tested and the level of stress desired for the pre-stressed corrosion test. In some embodiments, the material coupon 50 (e.g., rod 132) may feature fatigue pre-cracks or notches formed into the material coupon 50 prior to the coupon 50 being pre-loaded in the tensile loading assembly 130. These pre-cracks, notches, and/or other deformities in the material may be used to simulate stress concentrations that could be present in damaged production components. The resulting corrosion resistance analysis of the pre-cracked coupons may provide a more full understanding of the behavior of particular materials under stress.

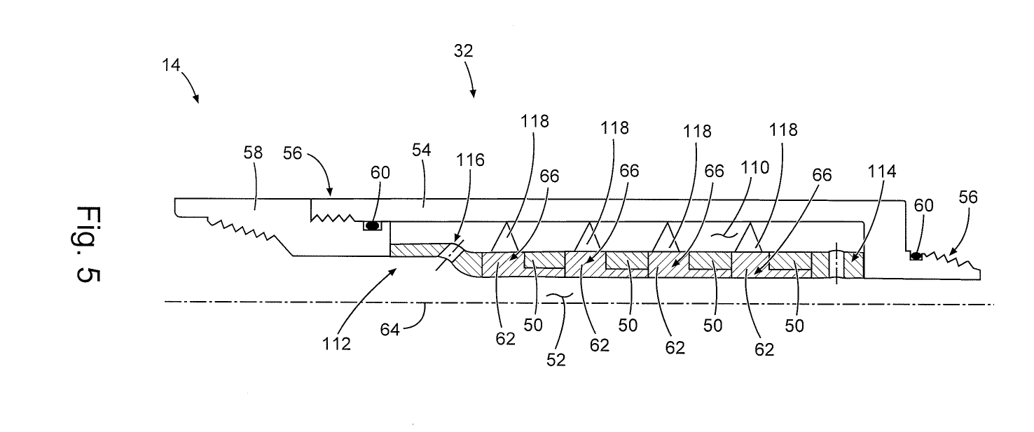

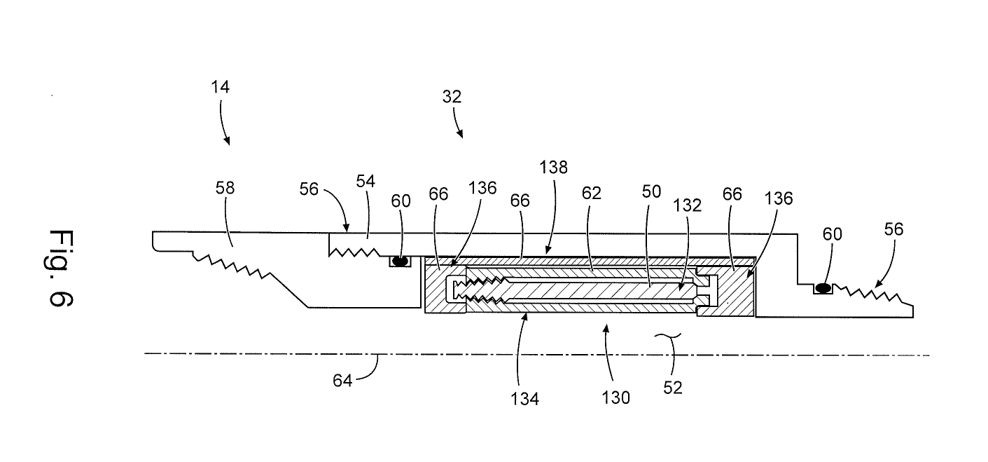

Another embodiment of a tensile loading assembly 130 that may be used in a pre-stressed version of the CTT is illustrated in FIG. 7. In the illustrated embodiment, the tensile loading assembly 130 may include a turnbuckle 150 used to provide the desired pre-stress to the material coupon 50. The material coupon 50 may be a rectangular or rod shaped coupon coupled between two opposite end fasteners 152 of the turnbuckle 150. The end fasteners 152 may include threads for engaging with complementary threaded portions at the ends of the material coupon 50. The end fasteners 152 may each be separate components coupled together via longitudinally extending threaded portions 154 that are screwed into opposite ends of a frame 156. Rotating the frame 156 relative to the threaded portions 154 may increase or decrease the distance between the end fasteners 152, thereby changing the amount of tension applied to the material coupon 50.

It should be noted that other types of tensile loading assemblies 130 may be implemented in other embodiments of the CTT 32 to pre-stress the material coupons 50. The tensile loading assemblies 130 described above with reference to FIGS. 6 and 7 may be incorporated into the CTT 32 designed for exposing the material coupons 50 to dynamic fluid flows (e.g., FIG. 2), or into the CTT 32 designed for exposing the material coupons 50 to near static fluid flows (e.g., FIG. 5). In addition, the tensile loading assemblies 130 of the CTT 32 may be arranged in the turbine configuration described above with reference to FIG. 4, in order to accommodate several pre-stressed coupons 50 within an internal space of the CTT 32.

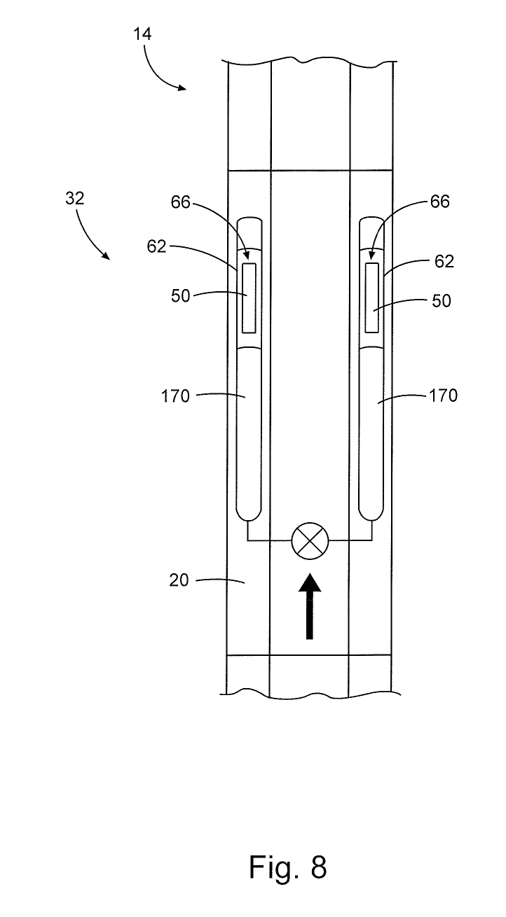

Some embodiments of the CTT 32 may be built into other components of the DST tubular string 14 described above in FIG. 1. For example, FIG. 8 shows an embodiment of the DST tubular string 14 having the material coupons 50 situated within the downhole fluid sampler 20 used to collect formation fluids for evaluation at the surface. As illustrated, the coupons 50 may be disposed in sample bottles 170 within the fluid sampler 20, along with the mounting features 62 and the electrical insulating material 66. As described at length above, the electrical insulating material 66 may be used to form at least a portion of, all of, or a coating on the mounting features 62.

The illustrated placement of the material coupons 50 may enable the CTT 32 to perform long run corrosion tests on the material coupons 50. Such long-run tests typically involve lowering sample materials into the wellbore (e.g., on a wireline) and holding them downhole for a long period of time. To save time spent downhole, the illustrated coupons 50 may instead be exposed to fluid collected into sample bottles 170 of the fluid sampler 20. The coupons 50 may be exposed to the fluid in the sample bottles 170 for the appropriate length of time for the long-run test, without the CTT 32 having to be disposed in the wellbore for longer than the initial DST performed by the DST tubular string 14. This may allow operators to perform long-run corrosion tests for a fraction of the cost typically used to expose coupons to downhole conditions for the long period of test time.

It may be desirable for the CTT 32 to include a temperature control system for maintaining the sample bottles 170 with the corrosion test material coupons 50 at approximately the same downhole temperatures throughout the entire test time. This may enable the sample bottles 170 to be retrieved at the surface while continuing the corrosion test for a relatively long period of time at similar downhole conditions. Once the bottles 170 are retrieved, they may be temperature controlled in a lab to maintain the corrosion test within a desired downhole temperature range.

Regardless of the types of CTT 32 used to perform corrosion tests on the various material coupons 50, these coupons 50 may be analyzed after the DST is performed to determine a corrosion resistance of the material coupons 50 as taken under wellbore conditions. To that end, the coupons 50 may be analyzed by measuring a uniform or generalized corrosion ASTM G1. This may involve performing a chemical cleaning of the material coupons 50 to remove any corrosion product. Other tests that could be used may include localized corrosion evaluation ASTM G46, surface inspection of the coupon 50 with a microscope, 3D pitting reconstruction, hydrogen desorption, corrosion layer measurements and analysis, and corrosion products identification via X-ray diffraction (XRD). Other tests and methods may be used in addition to, or in lieu of, those mentioned above to determine which of the materials to use for production tubing/equipment within the wellbore.

Embodiments disclosed herein include:

A. A corrosion tester tool for use on a drill stem test (DST) string. The corrosion tester tool includes an external tool housing and a material coupon disposed inside the external tool housing. The corrosion tester tool also includes a mounting feature for mounting the material coupon inside the external tool housing to expose the material coupon to formation fluid routed through the corrosion tester tool and the DST string. In addition, the corrosion tester tool includes an electrical insulation material disposed inside the external tool housing proximate the material coupon to prevent galvanic corrosion of the material coupon.

B. A system including a drill stem test (DST) string and a corrosion tester tool (CTT). The DST string includes an isolation component for isolating a section of a wellbore drilled through a formation and a valve for facilitating a flow of formation fluid from the formation into the DST string. The CTT is coupled to the DST string, and the CTT includes one or more material coupons mounted therein and arranged to be exposed to the formation fluid routed through the DST string.

C. A method includes exposing one or more material coupons disposed in a corrosion tester tool (CTT) coupled along a drill stem test (DST) string to a flow of formation fluid routed through the DST string while performing a drill stem test. The method also includes analyzing the one or more material coupons after performing the drill stem test to determine a corrosion resistance of the one or more material coupons.

Each of the embodiments A, B, and C may have one or more of the following additional elements in combination: Element 1: wherein the mounting feature includes the electrical insulation material. Element 2: wherein the mounting feature is disposed along an inner diameter of the external tool housing to expose the material coupon to a dynamic flow of formation fluid routed through a central flow passage of the corrosion tester tool. Element 3: wherein the mounting feature includes grooves formed on a portion of the mounting feature to increase a turbulence of the dynamic flow of formation fluid through the central flow passage. Element 4: further including a plurality of material coupons arranged in a turbine configuration within the external housing tool via the mounting feature. Element 5: further including a mandrel disposed within the external tool housing, wherein the mounting feature includes at least a portion of the mandrel to expose the material coupon to a near static flow of formation fluid routed through an annulus between the mandrel and the external tool housing. Element 6: further including a centralizer disposed on an outer edge of the mounting feature extending toward the external tool housing to facilitate near static conditions of formation fluid along a surface of the material coupon. Element 7: further including a tensile loading assembly having the mounting feature for holding the material coupon under tensile stress during exposure of the material coupon to the formation fluid. Element 8: wherein the tensile loading assembly includes end caps made from the electrical insulation material. Element 9: wherein the mounting feature includes a tensile loading sleeve for holding a rod of the material coupon under tensile stress, or wherein the mounting feature includes a tensile loading rod for holding a sleeve of the material coupon under tensile stress. Element 10: wherein the mounting feature includes a turnbuckle coupled between two opposing ends of the material coupon. Element 11: wherein the material coupon includes one or more fatigue pre-cracks or notches formed therein. Element 12: further including a sample bottle for collecting a sample of the formation fluid routed through the corrosion tester tool, wherein the mounting feature, the electrical insulation material, and the material coupon are disposed in the sample bottle.

Element 13: wherein the one or more material coupons are arranged to be exposed to a dynamic flow of fluid through a central flow passage of the CTT. Element 14: wherein the one or more material coupons are arranged to be exposed to a near static flow of fluid routed through an annulus formed in the CTT. Element 15: wherein the one or more coupons are mounted under tensile stress in the CTT.

Element 16: further including mounting the one or more material coupons in the CTT via electrically insulating mounting features. Element 17: further including selecting a material for use in production tubing/equipment based on the corrosion resistance of the material coupons.

Although the present disclosure and its advantages have been described in detail, it should be understood that various changes, substitutions and alterations can be made herein without departing from the spirit and scope of the disclosure as defined by the claims.

What is claimed is:

1. A corrosion tester tool for use on a drill stem test (DST) string, the corrosion tester tool comprising:
an external tool housing;
a material coupon disposed inside the external tool housing;
a mounting feature for mounting the material coupon inside the external tool housing to expose the material coupon to formation fluid routed through the corrosion tester tool and the DST string; and
an electrical insulation material disposed inside the external tool housing proximate the material coupon to prevent galvanic corrosion of the material coupon.

2. The corrosion tester tool of claim 1, wherein the mounting feature comprises the electrical insulation material.

3. The corrosion tester tool of claim 1, wherein the mounting feature is disposed along an inner diameter of the external tool housing to expose the material coupon to a dynamic flow of formation fluid routed through a central flow passage of the corrosion tester tool.

4. The corrosion tester tool of claim 3, wherein the mounting feature comprises grooves formed on a portion of the mounting feature to increase a turbulence of the dynamic flow of formation fluid through the central flow passage.

5. The corrosion tester tool of claim 1, further comprising a plurality of material coupons arranged in a turbine configuration within the external housing tool via the mounting feature.

6. The corrosion tester tool of claim 1, further comprising a mandrel disposed within the external tool housing, wherein the mounting feature comprises at least a portion of the mandrel to expose the material coupon to a near static flow of formation fluid routed through an annulus between the mandrel and the external tool housing.

7. The corrosion tester tool of claim 6, further comprising a centralizer disposed on an outer edge of the mounting feature extending toward the external tool housing to facilitate near static conditions of formation fluid along a surface of the material coupon.

8. The corrosion tester tool of claim 1, further comprising a tensile loading assembly having the mounting feature for holding the material coupon under tensile stress during exposure of the material coupon to the formation fluid.

9. The corrosion tester tool of claim 8, wherein the tensile loading assembly comprises end caps made from the electrical insulation material.

10. The corrosion tester tool of claim 8, wherein the mounting feature comprises a tensile loading sleeve for holding a rod of the material coupon under tensile stress, or wherein the mounting feature comprises a tensile loading rod for holding a sleeve of the material coupon under tensile stress.

11. The corrosion tester tool of claim 8, wherein the mounting feature comprises a turnbuckle coupled between two opposing ends of the material coupon.

12. The corrosion tester tool of claim 8, wherein the material coupon comprises one or more fatigue pre-cracks or notches formed therein.

13. The corrosion tester tool of claim 1, further comprising a sample bottle for collecting a sample of the formation fluid routed through the corrosion tester tool, wherein the mounting feature, the electrical insulation material, and the material coupon are disposed in the sample bottle.

14. A system, comprising:
a drill stem test (DST) string comprising an isolation component for isolating a section of a wellbore drilled through a formation and a valve for facilitating a flow of formation fluid from the formation into the DST string; and
a corrosion tester tool (CTT) coupled to the DST string, wherein the CTT comprises one or more material coupons mounted therein and arranged to be exposed to the formation fluid routed through the DST string.

15. The system of claim 14, wherein the one or more material coupons are arranged to be exposed to a dynamic flow of fluid through a central flow passage of the CTT.

16. The system of claim 14, wherein the one or more material coupons are arranged to be exposed to a near static flow of fluid routed through an annulus formed in the CTT.

17. The system of claim 14, wherein the one or more coupons are mounted under tensile stress in the CTT.

18. A method, comprising:
exposing one or more material coupons disposed in a corrosion tester tool (CTT) coupled along a drill stem test (DST) string to a flow of formation fluid routed through the DST string while performing a drill stem test; and
analyzing the one or more material coupons after performing the drill stem test to determine a corrosion resistance of the one or more material coupons.

19. The method of claim 18, further comprising mounting the one or more material coupons in the CTT via electrically insulating mounting features.

20. The method of claim 18, further comprising selecting a material for use in production tubing/equipment based on the corrosion resistance of the material coupons.
